(19) United States
(12) Patent Application Publication
(10) Pub. No.: US 2010/0045943 A1
(43) Pub. Date: Feb. 25, 2010

(54) Projector Mount

(75) Inventor: John Michael Gillespie, Green Oaks, IL (US)

Correspondence Address: FOLEY & LARDNER LLP, 321 NORTH CLARK STREET, SUITE 2800, CHICAGO, IL, 60654-5313, US

(73) Assignee: Peerless Industries, Inc.

(21) Appl. No.: 12/197,652

(22) Filed: Aug. 25, 2008

(51) Int. Cl. G03B 21/10

(52) U.S. Cl. 353/79

(57) ABSTRACT

A mount for mounting a projector and a display screen to a mounting surface. In one set of embodiments, the mount comprises a mounting bracket for attachment to a mounting surface, a carriage operatively connected to the mounting bracket and slidable in relation to the mounting bracket. The carriage is configured for operative connection to a display screen and operative connection of a projector adapted to project an image onto the display screen. The display screen is selectively positionable in relation to the mounting surface. Repositioning of the display screen simultaneously repositions the projector, substantially maintaining the orientation of the projected image in relation to the display screen.

### FIELD OF THE INVENTION

The present invention relates generally to the field of projector mounting systems. More particularly the present invention relates to devices for mounting both a projector and a display screen to a mounting surface.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various systems for mounting projectors are known, with the projectors being used to display images on a screen or surface. Some such mounting systems provide for mounting or resting the projector on a table or a fixture rising above the floor in front of the screen. Other such systems are configured to suspend the projector from a ceiling in front of the screen. Still other systems mount the projector from a wall adjacent to the screen. With each of these systems, the projector is generally positioned between the user and the screen and between the viewing audience and the screen. Accordingly, the projector may interfere with the ability of at least a portion of the audience to view the projected images on the display screen. Further, light from the projector, which may be intense, may be in the line of sight of the user of the projector, causing discomfort or visual strain. Additionally, when the user stands before the display screen, the projector may cast the user's shadow onto screen, detracting from audience's attention or enjoyment of the projected images.

To overcome limitations of using conventional projectors, various “short-throw” projectors have been developed that permit a projector to be positioned relatively near to a display screen but still provide a relatively large projected image. When properly mounted, such projectors may mitigate interference effects with the audience, operator discomfort, and shadow effects associated with conventional projectors.

### SUMMARY OF THE INVENTION

Various embodiments of the present invention comprise systems for mounting a projector and a display screen to a mounting surface. Embodiments of the system are selectively adjustable such that position of the projector and/or the display screen may be adjusted in relation to the mounting surface.

In one set of embodiments, the projector mount comprises a mounting bracket adapted for attachment to a mounting surface such as a wall, ceiling, floor, or fixture surface. The mounting bracket is configured to be operatively connected to a display screen and a projector. The projector mount may further comprise a carriage operatively connected to the mounting bracket and slidingly constrained in relation to the mounting bracket. The carriage is generally selectively slidable in relation to the mounting surface in a plane substantially parallel to the mounting surface. A biasing member operatively connected to mounting bracket and the carriage may further be provided to retain the position of the carriage in relation to the mounting bracket. The carriage may be adapted to operatively connect to the display screen. One or more intermediate brackets and/or adapters may be use to facilitate the connection between the carriage and the display screen. Accordingly, the display screen may be selectively slidable with the carriage in relation to the mounting surface.

The projector mount may further comprise a projector support operatively connected to the mounting bracket. The projector support may be adapted to operatively connect to the projector and is generally configured to orientate the projector relative to the display screen such that an image may be projected by the projector onto the display screen. The projector support may further be operatively connected to the carriage and thus selectively slidable with the carriage in relation to the mounting surface. The biasing member may be configured to balance the weight of the carriage, the display screen, the projector support and the projector mount, and the projector, thereby reducing the magnitude of force required to selectively maneuver the carriage. Thus, where the display screen and the projector support are operatively connected to the carriage, the orientation of the projected image remains substantially fixed in relation to the display screen regardless of the orientation of the display screen in relation to the mounting surface.

Thus, various embodiments provide a projector mount that efficiently orientates a projector in relation to a display screen, such as a projection screen or a white board. Various embodiments further provide for an adjustable mount that permits the display screen to be selectively positioned in relation to the mounting surface without requiring adjustment of the projector. For instance, a user may find that a particular display screen height is optimal for displaying projected images, while another height is better suited to marking on the display screen. Similarly, each user may have a preferred display screen position. Accordingly, embodiments provide a projector mount that permits efficient repositioning of the display screen to suit a user and/or the viewing audience but does not disrupt the orientation of the projected image in relation to the display screen.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a projector mount constructed according to one embodiment of the present invention;

FIG. 2 is a perspective view of the carriage and the mounting bracket of the projector mount of FIG. 1;

FIG. 3 is a perspective view of the mounting bracket, the carriage, the projector support, and the display screen adapter of the projector mount of FIG. 1;

FIGS. 4A and 4B are perspective views of a display screen and an associated mounting bracket adapted for operative connection to the projector mount of FIG. 1;

FIG. 5A is a perspective view of the projector mount of FIG. 1 operatively connected to the display screen of FIG. 4A, and FIG. 5B is a magnified view of the projector mount depicted in FIG. 5A;

FIGS. 6A and 6B are perspective views of the mounting bracket and the carriage of the projector mount of FIG. 1;

FIG. 7A is a perspective view of the projector support and adjustable projector bracket of the projector mount of FIG. 1, and FIG. 7B is a magnified view of the projector support of FIG. 7A;

FIG. 8A is a partial exploded view of the projector support and adjustable projector bracket of FIG. 1, and FIG. 8B is a top plan view of the projector support of FIG. 1;

FIG. 9 is a partial exploded view of a projector and associated brackets for operative connection to the projector mount of FIG. 1;

FIGS. 10A and 10B are partial exploded views of the carriage and a biasing member of the projector mount of FIG. 1; and

FIG. 11 is perspective view of the mounting bracket, the carriage, and the biasing members.

### DETAILED DESCRIPTION OF VARIOUS EMBODIMENTS

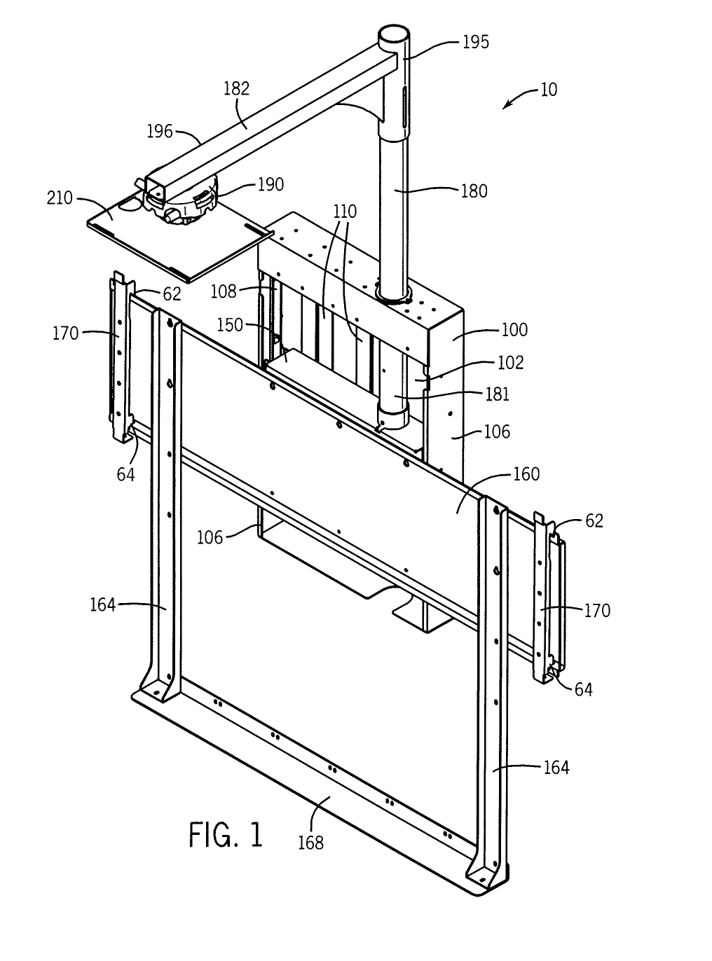

FIG. 1 illustrates a projector mount 10 constructed in accordance with an embodiment of the present invention. The projector mount 10 comprises a mounting bracket 100 and a projector support 180 operatively coupled to the mounting bracket 100. The projector mount 10 may further comprise a carriage 150 operatively connected to the mounting bracket 100 and a projector bracket 190 operatively coupled to the projector support 180. The projector mount 10 may also include a plurality of biasing members 110 operatively connected to the mounting bracket 100 and the carriage 150. The carriage 150 may further be selectively positioned in relation to the mounting bracket 100.

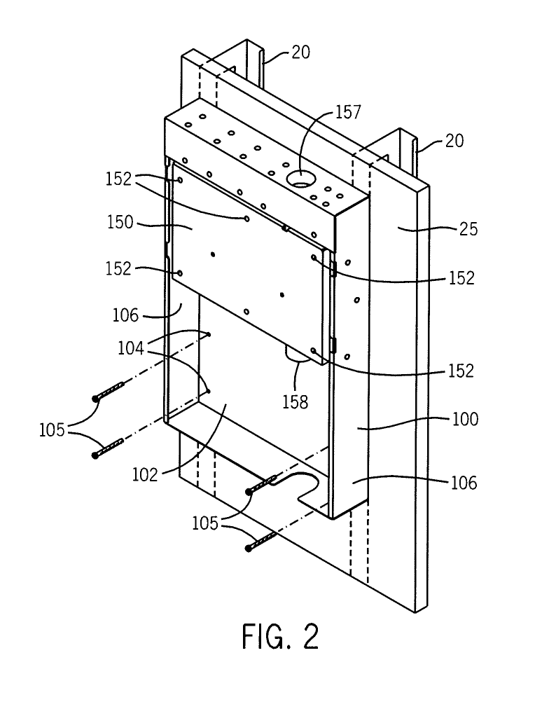

With reference to FIGS. 1 and 2, the mounting bracket 100 generally comprises an box-like structure adapted for securement to a mounting surface such as a wall, floor, ceiling, or fixture surface. However, other configurations of the mounting bracket 100 may be constructed. In the depicted embodiment, the mounting bracket 100 comprises a substantially flat mounting plate 102. The mounting plate 102 is adapted for attachment to the mounting surface. In an embodiment, the mounting bracket 100 is configured to span between a pair of adjacent studs 20 of a standard wall construction 25. A plurality of mounting holes 104 are disposed on the mounting plate 102. The mounting holes 104 are configured to receive a plurality of screws 105 or other fasteners to secure the mounting bracket 100 to the mounting surface. Other embodiments of the mounting bracket 100 may be constructed, including embodiments where a bracket is configured to be at least partially received within a mounting surface, such as between adjacent studs in a wall.

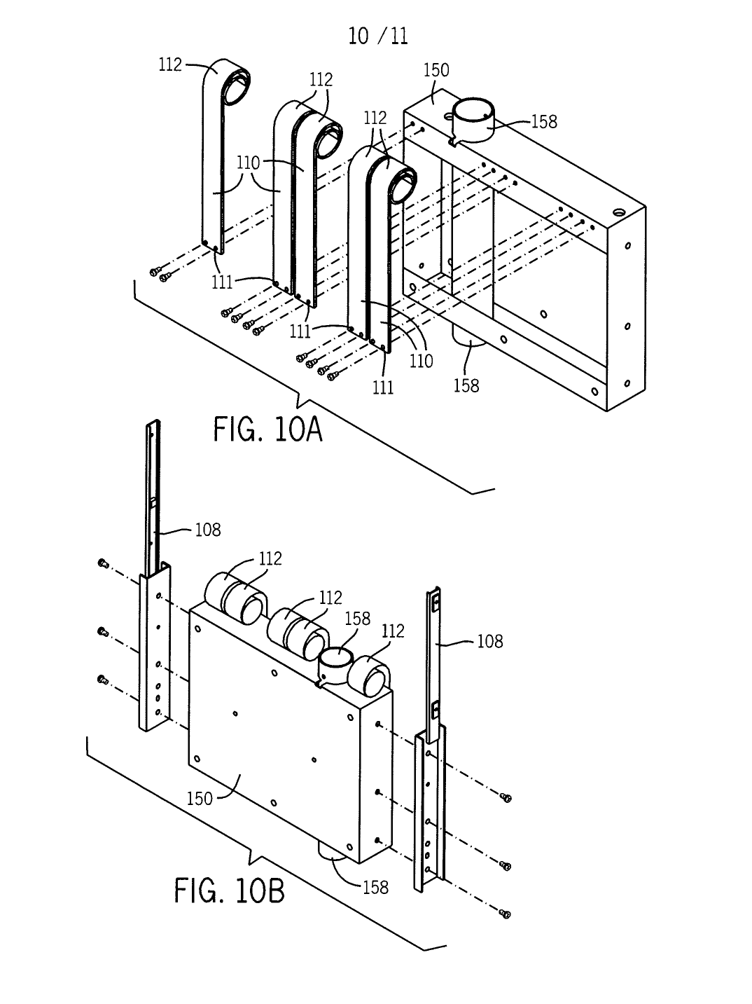

As depicted in FIGS. 1 and 2, a carriage 150 may be operatively connected to the mounting bracket 100. The mounting bracket 100 may further comprise a pair of side walls 106 extending substantially normal from the mounting plate 102. As shown in FIGS. 1 and 10B, a guide 108 may be disposed along a length of one or both of the pair of side walls 106. The carriage 150 may be operatively coupled to the guide 108, thereby slidingly constraining the carriage 150 in relation to the mounting bracket 100 in a plane substantially parallel to the mounting surface. Thus, as depicted in FIGS. 1 and 2, the carriage 150 may be selectively slid in a substantially vertical direction in relation to the mounting bracket 100. The configuration or orientation of the mounting bracket 100 is readily alterable to permit substantially horizontal sliding or movement of the carriage 150 in another direction.

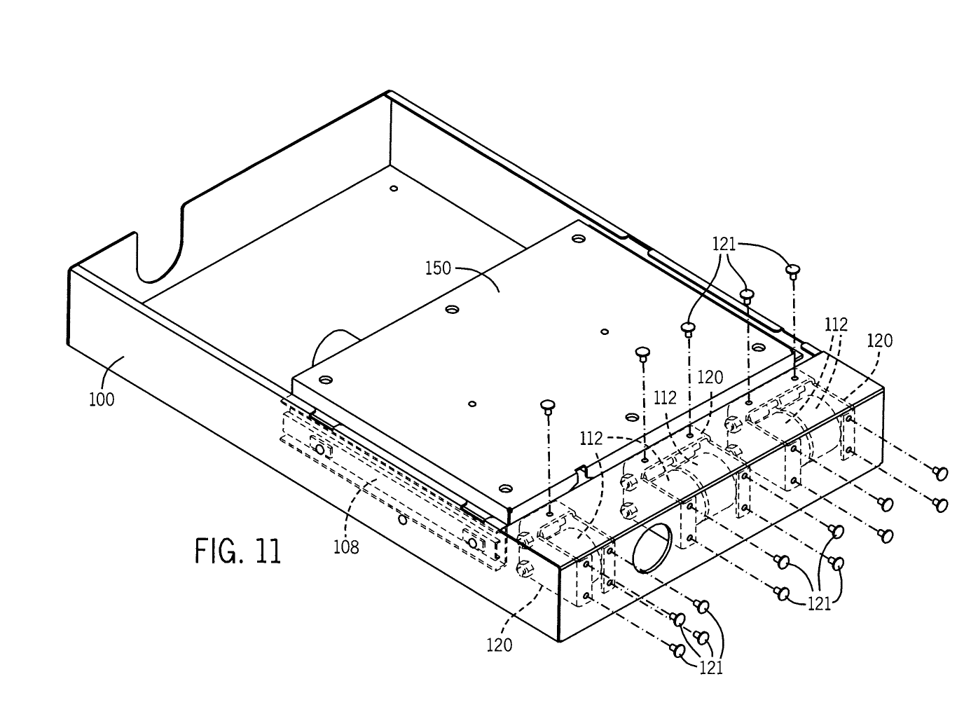

With reference to FIGS. 10A, 10B and 11, the projector mount 10 may include one or more biasing members 110 operatively connected to the mounting bracket 100 and the carriage 150. In the depicted embodiment, the one or more biasing members 110 comprise coil springs. However, other embodiments may be constructed using other types of biasing members. The one or more biasing members 110 are orientated such that the carriage 150 is biased substantially collinear in relation to its sliding path in the mounting bracket 100. The one or more biasing members 110 comprise a first end 111 and a second end 112 disposed substantially opposite the first end 111. The first end 111 is operatively connected to the carriage 150 and the second end 112 is operatively connected to the mounting bracket 100. As depicted in FIG. 11, the second end 112 may be received in a biasing member support 120. The biasing member support 120 may, in turn, be operatively connected to the mounting bracket 100. In the depicted embodiment, the biasing member support 120 is operatively connected the mounting bracket by a plurality of fasteners 121. The one or biasing members 110 may be configured to at least partially balance, in relation the mounting bracket 100, the weight of the carriage 150 and the features operatively connected to the carriage 150, including the display screen, the projector support 180, and the projector.

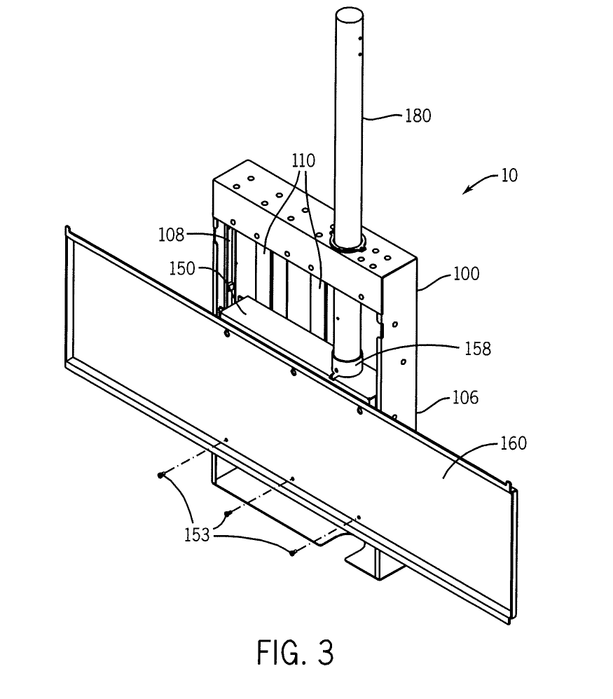

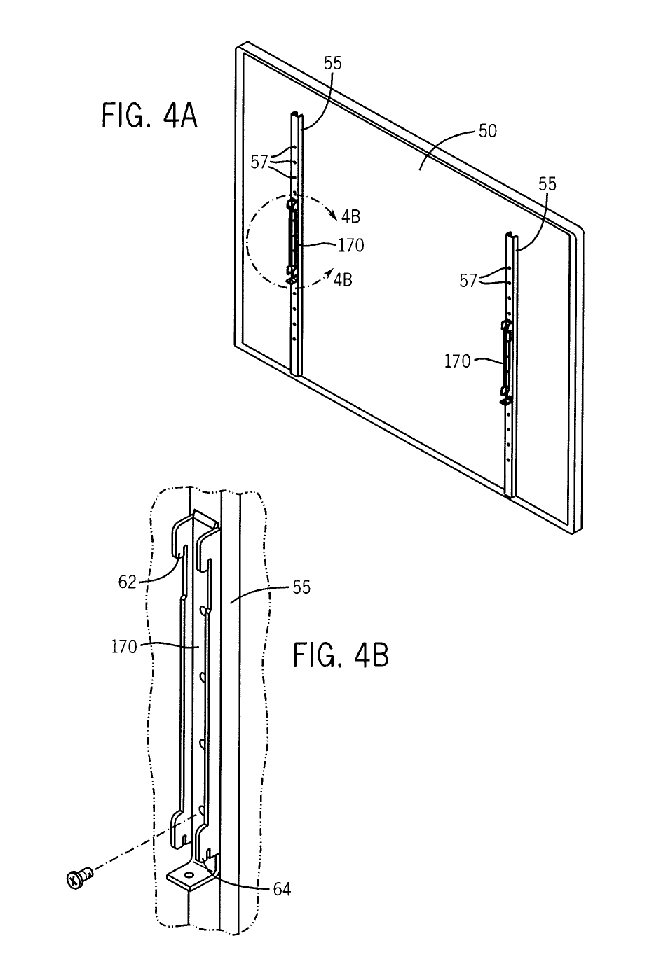

The carriage 150 may further include a plurality of holes 152 adapted to mount a display screen or an intermediate display screen adapter to the carriage 150. In the embodiment depicted in FIG. 3, a display adapter 160 is attached to the carriage 150 by a plurality of fasteners 153. The display screen may be mounted to the display adapter 160, or as shown in the embodiment of FIG. 4, one or more vertical handles 164 may be secured to the display adapter 160. A horizontal 168 handle may further be operatively connected to the display adapter 160 or the one or more vertical handles 164. The horizontal handle 168 may be configured with a ledge, shelf, compartment, or other feature to store associated objects.

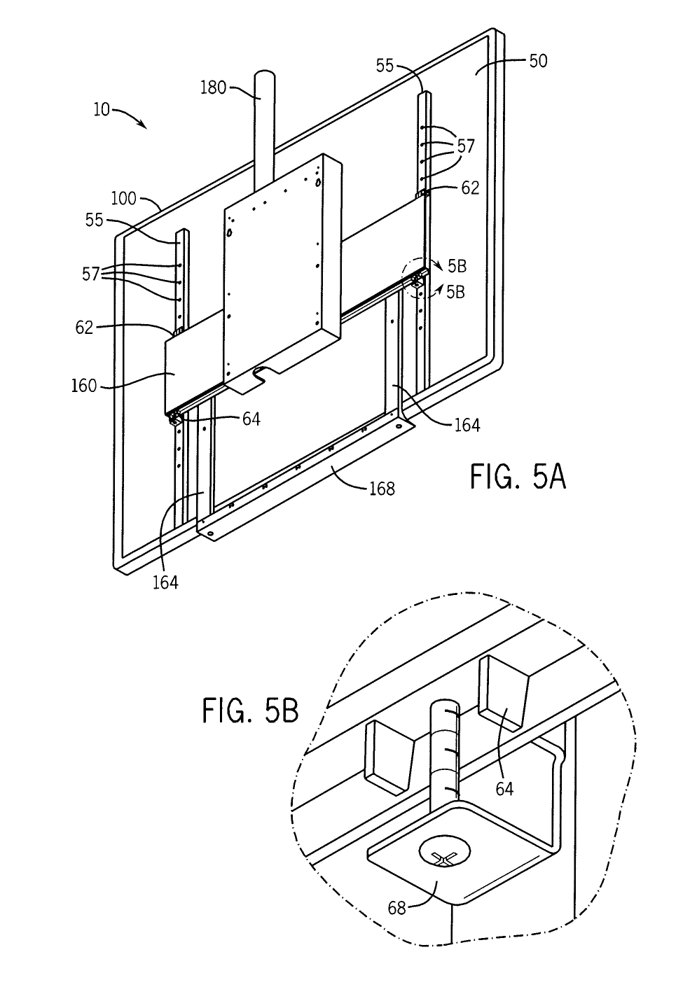

With reference to FIGS. 1, 4A and 4B, one or more hook brackets 170 may be operatively connected to the display screen 50. In the depicted embodiment, the display screen 50 includes a pair of substantially parallel screen brackets 55 disposed on the rear surface of the screen in a vertical orientation. The pair of substantially parallel screen brackets 55 include a plurality of holes 57 adapted to mount varying sizes of the display screen 50 to the projector mount 10. A hook bracket 170 is operatively connected to each of the pair of substantially parallel screen brackets 55. A first engagement feature 62 may be disposed at one end of the hook bracket 170. A second engagement feature 64 may be disposed at the opposite end of the hook bracket 60. As shown in FIG. 5, the display screen 50 may be mounted to the projector mount 10 by engagement of the first engagement feature 62 and the second engagement feature 64 with the display adapter 160.

The display screen 50 is readily attached and removed from the projector mount 10 through the above described mounting arrangement. An optional security screw 68 may be used to secure the display screen 50 to the projector mount 10. Other embodiments of the mounting bracket 100 may be constructed where the display screen 50 screen and/or an intermediate adapter or bracket is directly or operatively connected to mounting bracket 100.

A projector may be mounted to the projector mount 10 for orientation of the projector in relation to the display screen 50. The projector support 180 may be operatively connected to the mounting bracket 100. The projector support 180 generally comprises an elongated member with a substantially circular or other cross-section and may comprise a tube or other member. With reference to FIGS. 1-3, the projector support 180 may be operatively connected to the carriage 150 at a first end 181 of the projector support 180. A hole 157 adapted to receive the projector support 180 may be disposed on the mounting bracket 100. The carriage 150 may include a hole and further include one or more of a collar 158 disposed substantially coaxially with the hole 157 to receive the projector support 180.

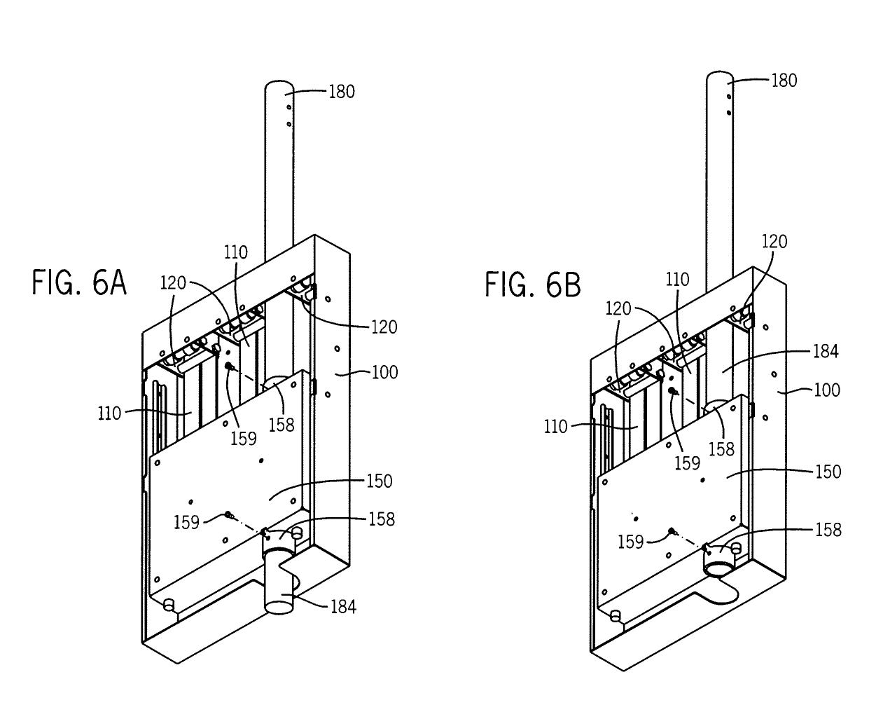

As shown in FIGS. 6A and 6B, the projector support 180 is inserted into the hole 157. The projector support 180 may optionally be secured to the carriage 150 by one or more fasteners 159 received by the collar 158 and a plurality of holes 184 disposed along a length of the projector support 180. In an embodiment, the plurality of holes 184 are disposed along the projector support 180 at intervals corresponding to various sizes of a display screen. Other embodiments may also be constructed, including a projector support 180 with a length selectively adjustable to support various sizes of a display screen.

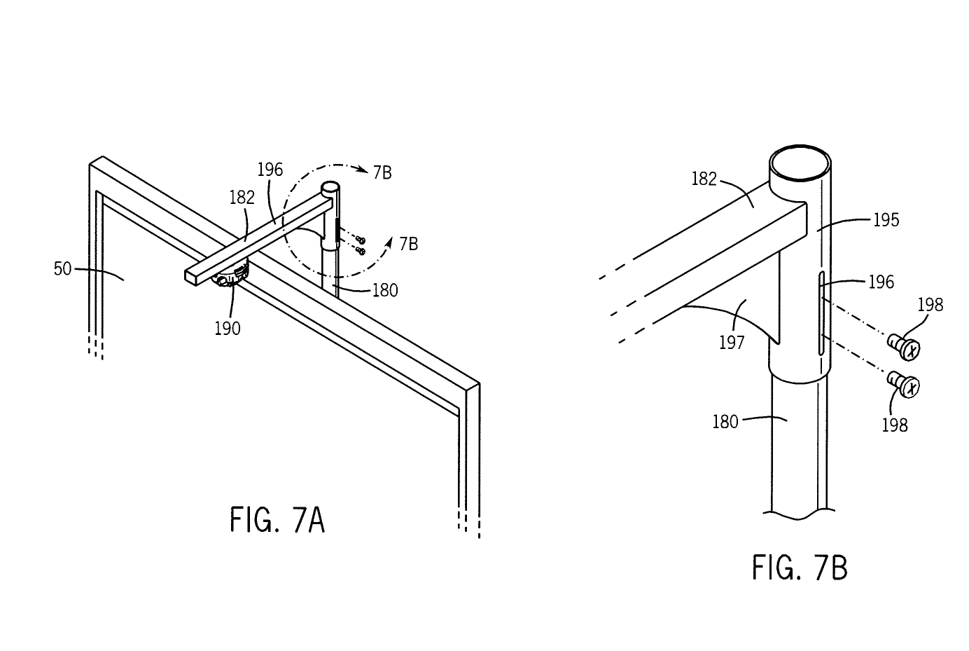

A projector is operatively connected to a second end 182 disposed substantially opposite the first end 181 of the projector support 180. With reference to FIGS. 7A and 7B, the projector may be operatively connected to a projector bracket 190, which is operatively connected to the second end 182. The second end 182 may extend away from the projector support 180 in a direction substantially normal to the mounting surface. In an embodiment, the second end 182 may be a separate component assembled to the projector support 180 through conventional techniques, including nesting members, welding, fastening, or other. A portion of the second end 182 may comprise a tube portion 195 configured to be at least partially received by the projector support 180 and an arm portion 196 operatively connected to the tube portion 195. The second end 182 may further optionally comprise a gusset 197 disposed in relation to the tube portion 195 and the arm portion 196. The tube portion 195 may be secured in relation to the projector support 180 by one or more fasteners 198. The tube portion 195 may include a slot 196 to receive the one or more fasteners 198 such that tube portion 195 may be selectively orientated in relation to the projector support 180.

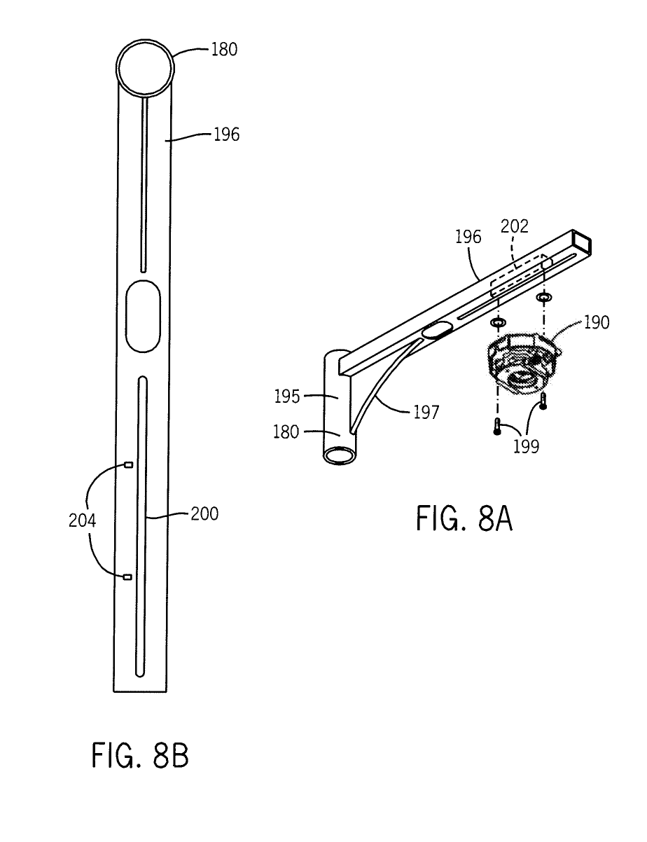

With reference to FIGS. 8A and 8B, the projector bracket 190 may be operatively connected to the arm portion 196 via one or more fasteners 199 or other securing feature. The arm portion 196 may include a plurality of holes adapted to receive the fasteners. Alternatively, as shown in FIGS. 10A and 10C, the arm portion 196 may include a slot 200 adapted to receive the one or more fasteners 199. The one or more fasteners 199 may operatively connect to a slide plate 202 disposed within the arm portion 196. The slot 200 permits the projector bracket 190 to be selectively positioned along a portion of the length of the arm portion 196, thereby accommodating a range of display screen sizes through adjustment of the projector bracket 190. A plurality of references 204 indicative of various sizes of display screens may optionally be disposed on the arm portion 196 to facilitate positioning of the projector bracket 190 in relation to the arm portion 196.

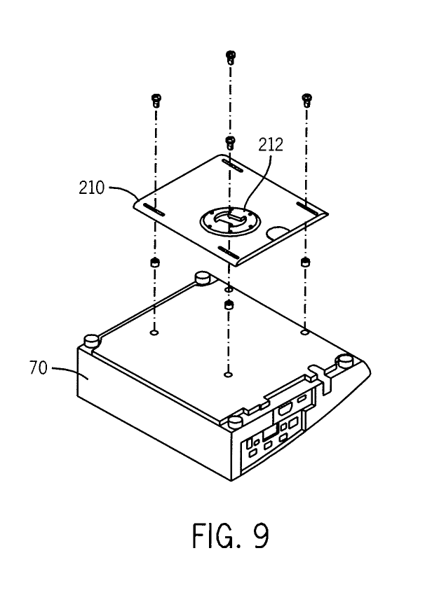

With reference to FIGS. 1 and 9, a projector 70 may be operatively coupled to the projector bracket 190. A projector adapter plate 210 adapted to interface with various projectors is secured to the projector 70 and may be operatively connected to the projector bracket 190. A connection block 212 may further be disposed in relation to the projector adapter plate 210. The connection block 212 may operatively connect to the projector bracket 190.

The projector bracket 190 may comprise an adjustable mounting bracket that permits selective orientation of the projector 70 in one or more directions in relation to the projector mount 10. In an embodiment, the projector bracket 190 allows for selective orientation of the projector 70 in at least two degrees of freedom. For example, the projector bracket 190 may be configured to permit rotation of the projector 70 about a first axis substantially normal to the display screen 50 and rotation about a second axis substantially parallel to the display screen. Various other embodiments of the projector bracket 190 may be constructed permitting rotation and/or translation of the projector 70 in relation to the projector mount 10.

Use of the projector mount 10 orientates the projector 70 and its projected image in relation to the display screen 50. Where the projector mount 10 includes the carriage 150, the position of the display screen may be selectively orientated in relation to the mounting surface. Thus, in an embodiment, the position of the display screen 50 may be adjusted to move the display screen 50 to suit a user's and/or a viewing audience's preferred height or horizontal position. Similarly, the projector mount 10 may be used to move the display screen 50 between a viewing position and a storage position. The position of the display screen 50 may be moved manually by an operator. The operator grasps a portion of the display screen 50 or the horizontal handle 168 and translates the display screen 50 to a position in relation to the mounting surface. The carriage 150 slides in relation to the mounting bracket 100 in response to the operator's action, thereby simultaneously repositioning the projector 70. The one or more biasing members 120 act to retain the position of the carriage 150 in relation to the mounting bracket 100 until a user again repositions the display screen 50, eliminating the need for the user to engage an additional apparatus to fix the position of the display screen 50. The biasing force of the one or more biasing members 120 also assists in maneuvering the display screen 50 and projector 70 during repositioning, thereby reducing the force that the user must apply to reposition the display screen 50. Additionally, the projector mount 10 may further comprise a motor operatively coupled to the carriage 150 for automated movement of the display screen 50 and the projector 70. The projector mount 10 may further comprise a remote control device to control the operation of the motor.

Where the projector 70 and the display screen 50 are operatively coupled to the projector mount 10, the orientation of the projected image in relation to the display screen 50 remains substantially fixed. Thus, the display screen 50 may be selectively positioned as desired without requiring adjustment or reorientation of the projector 70 or the projected image.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus, modules and systems.

What is claimed is:

1. A projector mount for mounting a projector and a display screen, comprising:
a mounting bracket adapted for mounting to a mounting surface;
a carriage operatively connected to the mounting bracket, the carriage selectively orientatable in relation to the mounting surface to a carriage position in a plane substantially parallel to the mounting surface, the carriage configured for operative connection to a display screen;
one or more biasing members, each of the one or more biasing members having a first end and a second end, the first end operatively connected to the carriage and the second end operatively connected to the mounting bracket; and
a projector support operatively connected to the carriage, the projector support configured for operative connection to a projector positioned to project at least a portion of an image at an image location on the display screen,
wherein the carriage position is substantially maintained by the one or more biasing members.

2. The projector mount of claim 1, wherein the image location is substantially maintained for any carriage position established by a user orientating the display screen in relation to the mounting surface.

3. The projector mount of claim 1, wherein the one or more biasing members comprise coil springs.

4. The projector mount of claim 1, wherein the carriage is configured for operative connection to the display screen such that the display screen is orientated in a plane substantially parallel to the mounting surface.

5. The projector mount of claim 1, wherein the carriage is movingly constrained in relation to the mounting bracket.

6. The projector mount of claim 5, wherein the carriage is movingly constrained in one of a substantially vertical direction and a substantially horizontal direction.

7. The projector mount of claim 6, wherein the carriage is capable of sliding at least about 6 inches.

8. The projector mount of claim 1, further comprising a display screen adapter operatively connected to the carriage, the display screen adapter configured for operative connection to the display screen.

9. The projector mount of claim 8, further comprising at least one handle operatively connected to the display screen, the handle configured for operative connection to the display screen.

10. The projector mount of claim 8, further comprising a plurality of substantially parallel handles operatively connected to the display screen adapter, and at least one orthogonal handle disposed substantially normal to the plurality of the handles and operatively connected to at least one of the plurality of handles.

11. The projector mount of claim 1, wherein the projector mount is adaptable to accommodate a plurality of screen sizes of the display screen.

12. The projector mount of claim 2, wherein the projector support is configured such that the operative connection between the projector support and projector is selectably positionable in relation to an axis substantially normal to the mounting surface.

13. The projector mount of claim 1, further comprising an adjustable projector bracket, the projector bracket operatively connected to the projector support, the projector bracket configured for operative connection to the projector.

14. The projector mount of claim 13, wherein the adjustable projector bracket is capable of selectively orientating the projector in at least a first degree of freedom and a second degree of freedom.

15. The projector mount of claim 14, wherein the first degree of freedom is a rotation about an axis substantially parallel to the mounting surface, and wherein the second degree of freedom is a rotation about an axis substantially normal to the mounting surface.

16. The projector mount of claim 1, further comprising a motor operatively coupled to the carriage, the motor configured to selectively orientate the carriage in relation to the mounting surface.

17. A projector mount for mounting a projector and a display screen, comprising:
a mounting bracket adapted for mounting to a mounting surface;
a carriage operatively connected to the mounting bracket, the carriage selectively orientatable in relation to the mounting surface to a carriage position in a plane substantially parallel to the mounting surface, the carriage movingly constrained in relation to the mounting bracket;
one or more biasing members, each of the one or more biasing members having a first end and a second end, the first end operatively connected to the carriage and the second end operatively connected to the mounting bracket, the one or more biasing members configured to substantially maintain the carriage position;
a display screen adapter operatively connected to the carriage, the display screen adapter configured for operative connection to a display screen;
a projector support operatively connected to the carriage; and
a projector bracket operatively connected to the projector support, the projector bracket configured for operative connection to a projector positioned to project at least a portion of an image at an image location on the display screen,
wherein the image location is substantially maintained for any carriage position established by a user orientating the display screen in relation to the mounting surface.

18. The projector mount of claim 17, wherein the projector support is configured such that the operative connection between the projector support and projector bracket is selectably positionable in relation to an axis substantially normal to the mounting surface.

19. A projector mount for mounting a projector and a display screen, comprising:
a mounting bracket adapted for mounting to a mounting surface;
a carriage operatively connected to the mounting bracket, the carriage selectively orientatable in relation to the mounting surface to a carriage position in a plane substantially parallel to the mounting surface, the carriage slidingly constrained in relation to the mounting bracket,
a display screen adapter operatively connected to the carriage, the display screen adapter configured for operative connection to a display screen;
a projector support operatively connected to the carriage; and
an adjustable projector bracket operatively connected to the projector support, the adjustable projector bracket configured for operative connection to a projector positioned to project at least a portion of an image at an image location on the display screen, the adjustable projector bracket configured to selectively orientate the projector in at least a first degree of freedom and a second degree of freedom,
wherein the projector mount automatically maintains the carriage position for any selected carriage position.

20. The projector mount of claim 19, wherein the automatically maintaining of the carriage position is accomplished by one or more biasing members, each of the one or more biasing member having a first end and a second end, the first end operatively connected to the carriage and the second end operatively connected to the mounting bracket.
